(19) United States
(12) Patent Application Publication
(10) Pub. No.: US 2009/0320302 A1
(43) Pub. Date: Dec. 31, 2009

(54) Square foot alignment device

(76) Inventor: William Boyd, Newark, DE (US)

Correspondence Address: WILLIAM BOYD, 602 TAMARA CIRCLE, NEWARK, DE, 19711, US

(21) Appl. No.: 12/215,361

(22) Filed: Jun. 25, 2008

(51) Int. Cl. G01C 5/00

(52) U.S. Cl. 33/262

(57) ABSTRACT

In such sports, as golf, foot alignment in a stance is an important. To obtain proper foot alignment is hard. There are many aids one could use to help a person to obtain a proper alignment. But, this invention/patent idea of a “ray line beam device” that is attached to the shoe gives a person an opportunity to line their feet properly.

### BACKGROUND

One of the biggest problems golfers have is a properly lined up stance. All levels of golfers may fall victim of lining up improper. To line your feet up square to the target in golf is a hard thing to do without someone behind you giving you their eyed up opinion of your stance and the target line. If a golfer can not be consistent with the placement of the feet and squaring up to the target, the golfer will never learn how to correctly hit a golf shot.

There have been training aids and gimmicks developed to help a golfer. But, most of them have been too big or too noticeable to bring out to the course to play or practice golf. Some of them are too complex.

### BRIEF SUMMARY OF THE INVENTION

This invention/patent will be a “ray line beam device/apparatus and marking” that is hooked/connected onto a shoe (permanently or removable). The ray line beam device will have a small “level” (21) on top of it and or it will have the capability to “self level” itself. The ray line device will either be permanently on the shoe or it will be a removable device that is securely attached when attached (8, 9, 22, 23, & 24). The ray line beam device may be an “1” ray beam line (perpendicular)(33), a “T” ray line beam (which would be an upside down “T”)(35), a “TT” ray line beam (36), “++” ray line beam (37) or a “+” ray line beam (34). The ray line beam device that attaches to the (back) shoe (11) will be compact to offer the least amount of interference (to no interference) to an athlete's movement. The marking has to be on the identical spot (12, 16 & 18) on the front shoe (10) as the back shoe (11) and where the ray line is coming from/generated.

The front shoe of the pair of shoes will have a line or mark (12, 16 & 18) that the ray line beam will have to shine over and the back shoe will have the ray line beam device/apparatus that shines a ray line beam in the direction of or on the target. Both of these will be located on the inside part of the shoe. The device will be hooked on the highest part of the shoe in that area of the shoe as possible. The back shoe ray line beam device/apparatus will give a straight ray line beam from the back shoe/foot of the person to a desired parallel point/direction or to a designated parallel target that a person wants the golf ball to go towards. The back shoe/foot will be on the ground in spot that is desired to strike the golf ball. The (straight) ray line beam will be pointing towards the parallel direction or to the parallel designated target. The ray line device may have the capability to calculate the distance of the designated parallel target. After the golfer is in correct position with the back shoe/foot; he or she will place the front shoe/foot in position. The front shoe/foot will have a designated line or mark on the shoe in the exact spot (12, 16 & 18) as the back shoe/foot has the ray line beam device (apparatus) attached (or built into the shoe). The ray line beam of the back shoe/foot will shine on the front shoe/foot and a person will be able to line their feet up square (if desired) by matching the ray line to the marking of the front shoe foot (FIG. 2).

A person has to have a pair of shoes with some sort of markings on the identical spot as the other shoe so that ray beam line can light up the front shoe from the same spot as the back shoe of where the ray line beam is coming from/generated. The ray line beam device will be attached on the highest part of the shoe in the particular area as possible (as high and far away from the sole of the shoe) (16 & 18). This will give the best results for ray line beam device to have a line on the ground. To hook a device low or even on the sole would have the problem of grass and other ground objects blocking the ray line beam.

The shoes can be made with these marking and device/apparatus (the invention) already on the shoe or a person can attach this marking and device/apparatus (the invention) to their existing pair of shoes. The marking and device/apparatus (the invention) should be in identical spots of the opposing shoe (left to right shoe) in the pair of shoes.

The pair of shoes could be manufactured with the invention already incorporated into the pair of shoes. This incorporation of the invention into the pair of shoes could be permanent or removable. Or, the invention could be totally separate from the manufactured pair of shoes and the invention could be added to any pair of shoes. However, the invention has to have the capability to be adjusted so the device can project a level ray line beam.

### BRIEF DESCRIPTION OF SEVERAL VIEWS OF THE DRAWINGS

FIG. 1

Shoes/Feet lined up right next to each other in an aerial view
1. Inside part of the shoes
2. Outside part of the shoes
3. Toe portion of the shoe
4. Heel portion of the shoe

FIG. 2

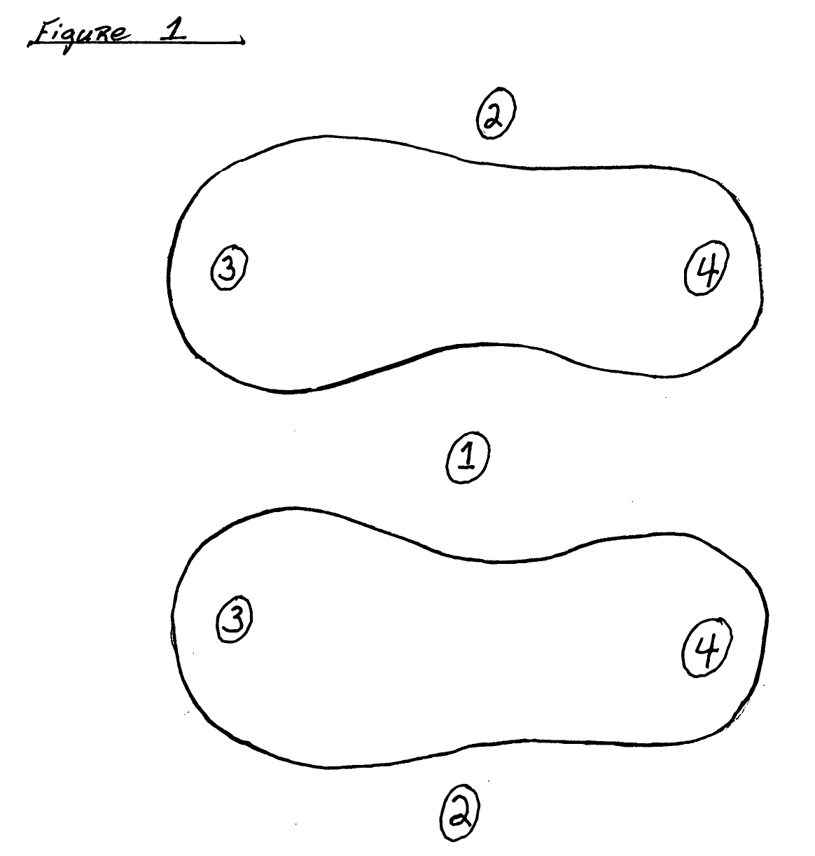

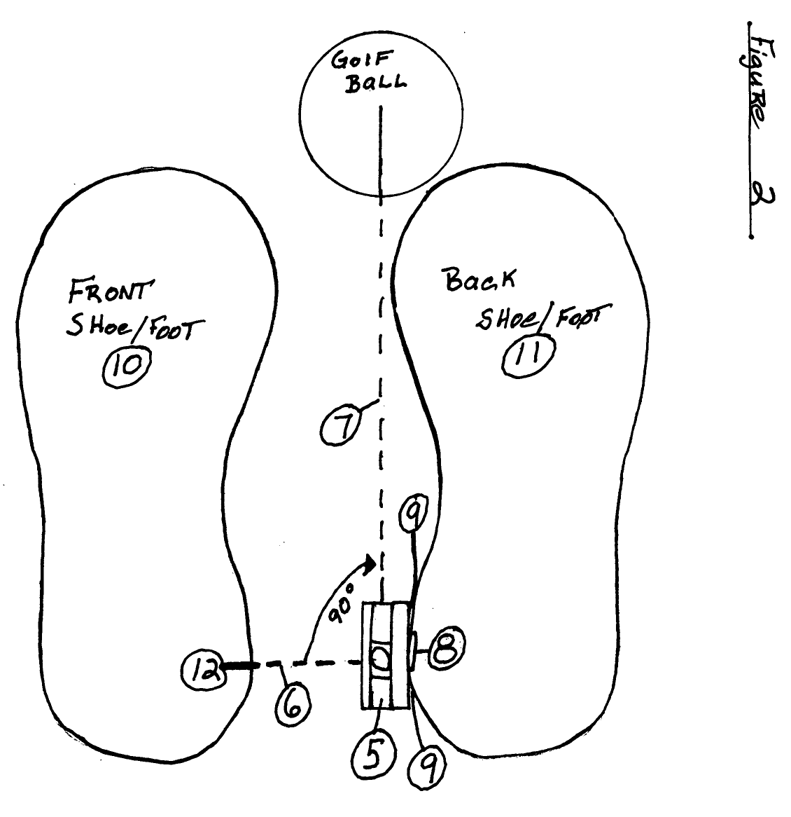

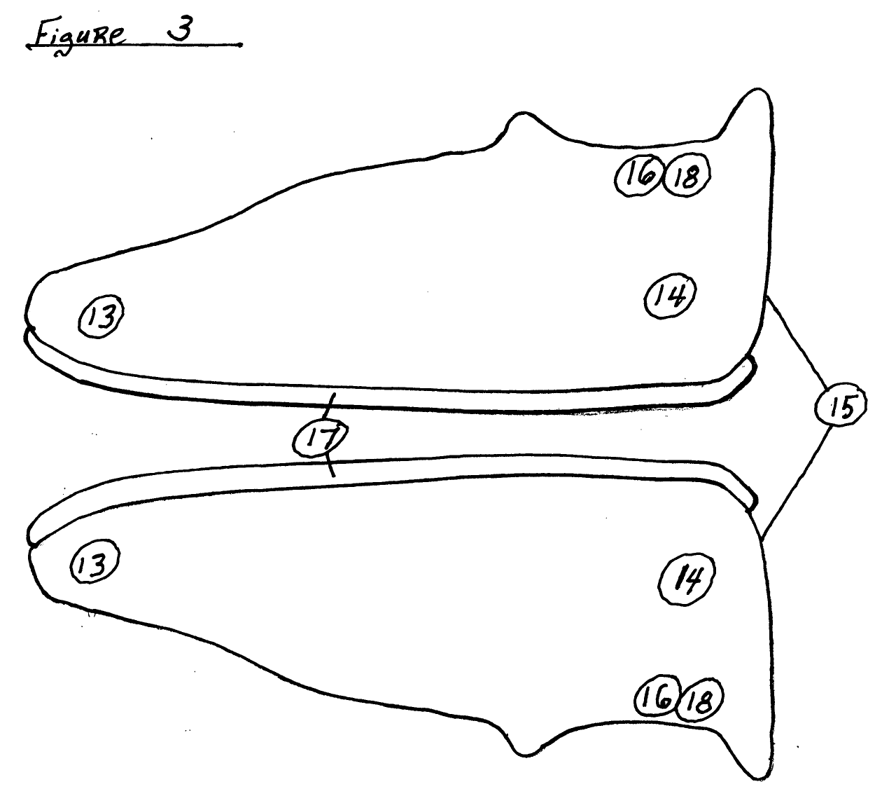

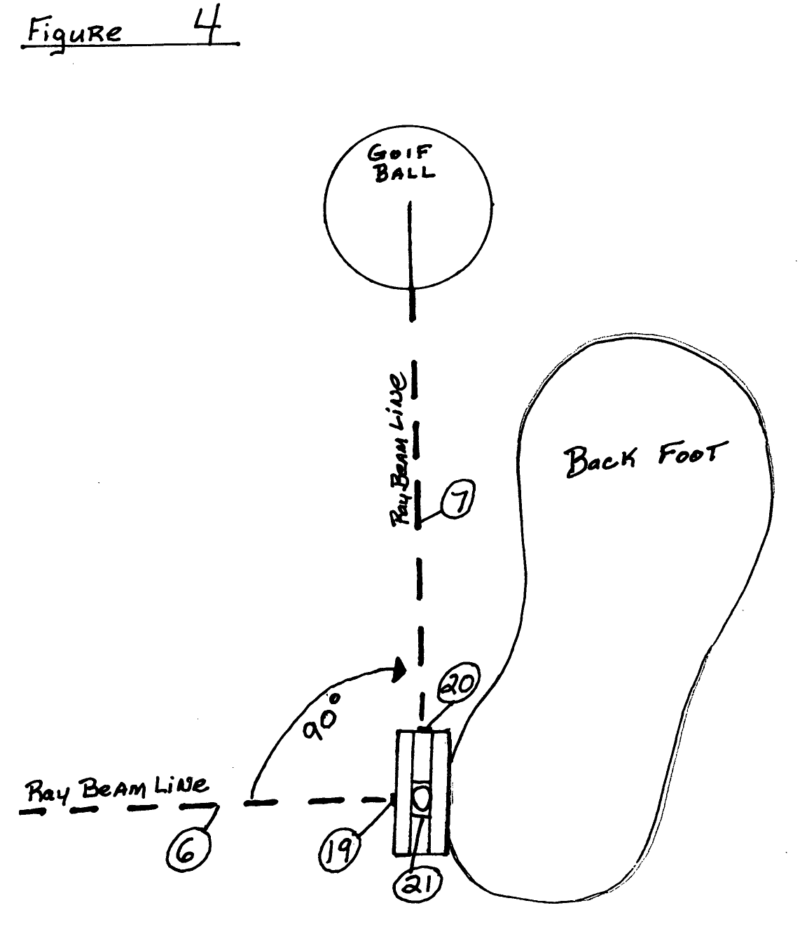

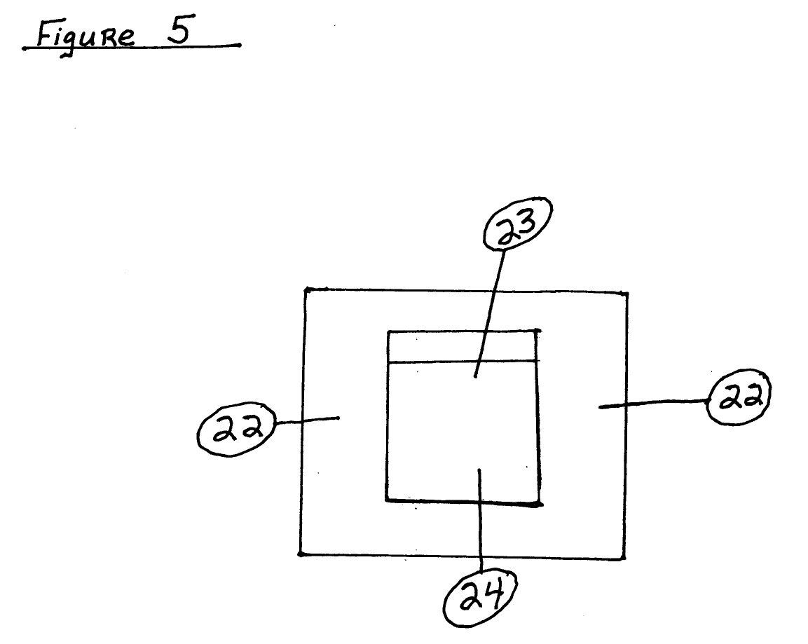

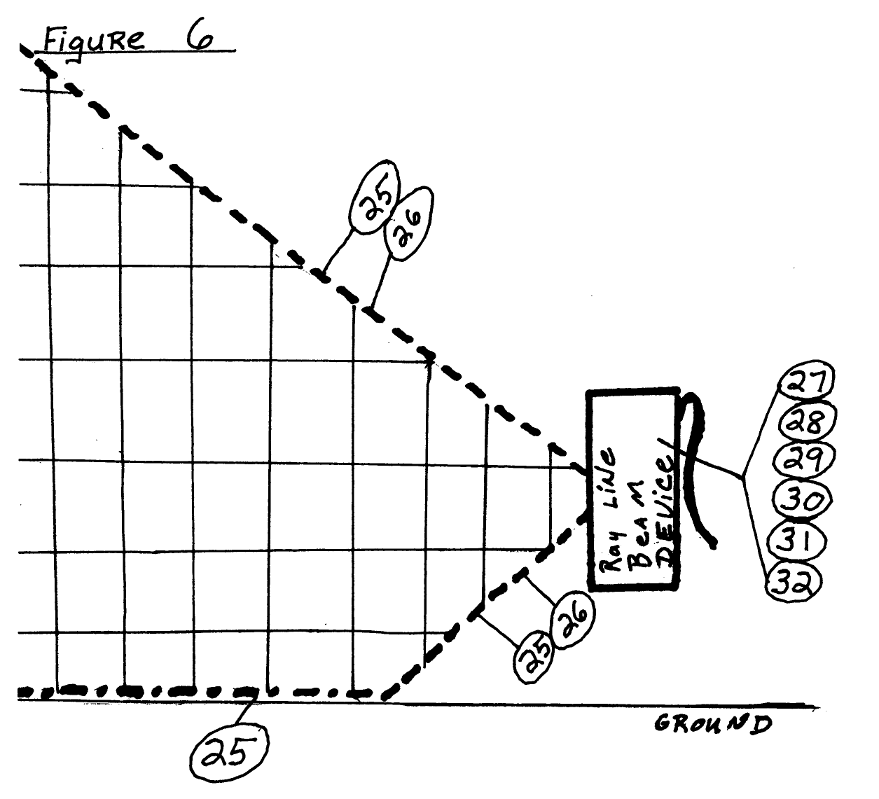

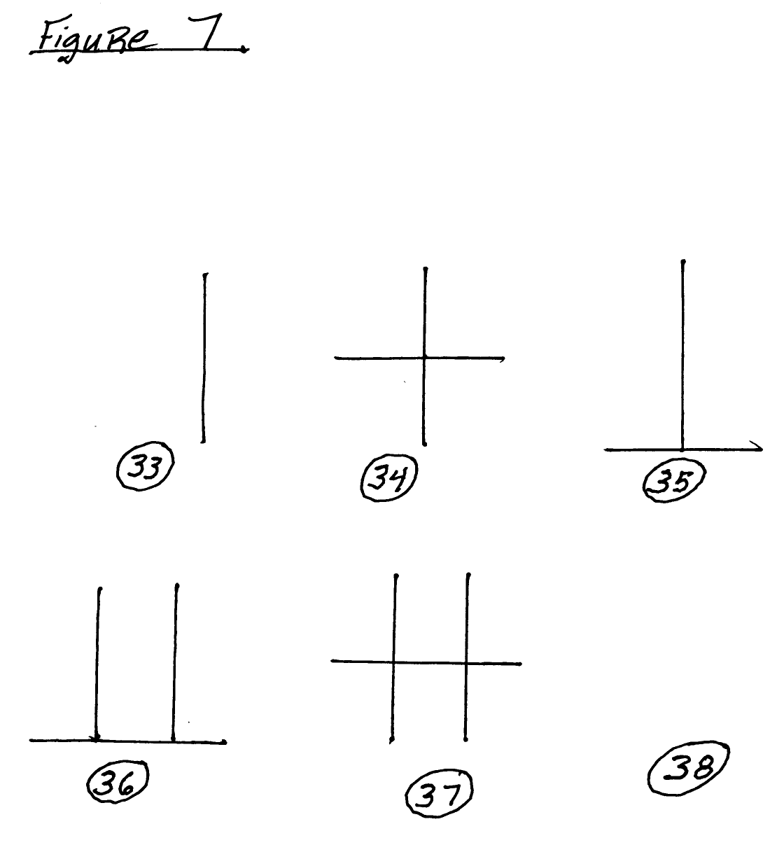

Shoes/Feet lined up right next to each other in an aerial view and device apparatus attached (the device apparatus may be a different shape and size)
5. Device/apparatus that can shine a ray line beams out
6. Straight ray line beam comes out shines on target line, target and on the inseam of the front shoe/foot
7. Straight ray line beam comes out and shines on the ball. This ray line beam is 90 degrees from #7's ray line beam
8. Clip on the device to hook to the shoe may be used
9. Velcro or some other attachment device may be used
10. Front shoe/foot
11. Back shoe/foot
12. Front shoe/foot ray line beam mark or device marker

FIG. 3

Side view of the pair of shoes
13. Toe to toe
14. Heel to heel
15. Shoe matches each other
16. Possible location for ray line beam device apparatus and the line mark (device or marking to be attached)
   Ray line beam device apparatus to be hooked on the inside part of the back shoe/foot (Right handed is the right foot and Left handed is the left foot)
   Line mark (device or marking) is to go on the inside part of the front shoe/foot (Right handed is the left shoe/foot and Left handed is the right shoe/foot)
   Ray line beam device is to be hooked on the upper part of the shoe
17. Sole of the shoe and the device apparatus is not to be hooked to the sole of the shoe
18. Top part of the shoe and the device apparatus is to be hooked to the highest part of the shoe as close to the top as possible. The device apparatus may even have an extension to make it go higher.

FIG. 4

Top view of device apparatus (the actual device apparatus may differ in shape and size) with one Ray line beam for the target and may be one ray line beam for the golf ball
19. Ray line beam that shines out to target, target line and the front shoe
   Shines straight along the ground on a target line
   Shines to a parallel target that may be on the ground an ground level or higher in the air or above ground level (e.g. tree branch)
   Shines a straight ray line beam to the front shoe/foot when the front shoe/foot is placed in front of back shoe/foot to obtain a persons golfing stance
   The ray line beam device may have a self leveling to be perpendicular to level ground
20. Ray line beam shines on the golf ball
   When the back shoe/foot is temporarily placed a fraction back from 90 degrees from the target and to the golf ball
   The ray line beam will shine 90 degrees from Ray Line Beam #6
   The ray line beam will shine on the ball and when the ray line beam #6 hits the target line and ray line beam #7 hits the golf ball a golfer will have 90 degree lines
21. A “level” may be on the top for the golfer to see if the device is perpendicular to level ground

FIG. 5

Top view of back of the device apparatus (the actual device apparatus may differ in shape and size
22. Velcro or some other attachment device may be attached to the back face of the device apparatus
23. Some sort of clip may be attached to the device apparatus
24. A slide extension may be attached to the device apparatus to allow the device to slide higher

FIG. 6

View of the Ray Line Beam
25. Ray line beam shines across the ground
26. Ray line beam shines out, upwards, and downwards at a preset degree
27. Ray line beam can shine on objects above ground level and below standing ground level
28. Ray line beam may have a self leveling capability to be perpendicular to level ground
29. Ray line beam may tell the distance of a target it shines on
30. Ray line beam device apparatus will have easy access for on and off
31. Ray line beam may have automatic shutoff in a preset designated time (e.g. 45 seconds)
32. Ray line beam may have a range of capability to shine (e.g. 2 feet to 1500 feet)

FIG. 7

View of possible Ray Line Beams and a ray
33. Perpendicular (to level ground) straight ray line beam up and down. Similar to a “1”
34. Perpendicular (to level ground) straight ray line beam and parallel (to level ground) straight ray line beam. Similar to a “+”
35. Perpendicular (to level ground) straight ray line beam and parallel (to level ground) straight ray line beam. Similar to a “T”
36. Two Perpendicular (to level ground) straight ray line beams and parallel (to level ground) straight ray line beam. Similar to a “TT”
37. Two Perpendicular (to level ground) straight ray line beams and parallel (to level ground) straight ray line beam. Similar to a “++”
38. A single ray

### DETAILED DESCRIPTION OF THE INVENTION

The invention/patent would be a ray line beam device/apparatus that would have capability to project a ray line beam that would shine out and could be hooked to a person's shoe. The ray line beam device/apparatus would have to have a small “level” tube on the top of it or the ray line beam device would have to be a self leveling ray line beam device. A golfer is rarely on level ground and when the ground is not level and/or the target is something off the ground (like a tree branch limb); the golfer's ray line beam target may be off dramatically if the device is not projecting a level ray line beam. Having a ray line beam level and/or consistent ray line beam would be a correct learning aid for the golfer. The ray line beam device/apparatus would be compact and have the ability to hook onto shoes permanently or removable (if removable it would have to be secure when attached to the shoe and the ability to adjust to level). A manufacturer of shoes could make the ray line beam device into being a part of the shoe or the ray line beam device could be purchased and attached to the shoe (securely). Either way, permanent or detachable, the ray line beam has to be able to rotate and adjust if the golfer desires (for such reasons as the ground not being level).

The ray line beam device would be able to hook on the highest part of the shoe in the particular area of the shoe as possible (16 & 18). (If a ray line beam device was hooked or made into the sole of a shoe; the ray line beam device would be interfered and made useless with grass, other ground level objects, dirt, or mud that the lower shoe and the sole of shoe competes with and sinks into. The ray line beam has to have clearance to shine its ray line beam.) The ray line beam device can be made to stand a little higher than the shoe just as long as the ray line beam device does not interfere with the golfer and the swing motion of the golfer.

The ray line beam device would have beam ray that would resemble “1” (33), an upside down “T” (35), a “+” (34), “++” (37) and or “TT” (36). The ray line beam device may have the capability to tell the distance of the target object. The ray line beam device would have an accessible on and off. The ray line beam device may have the capability of staying on for a designated time. For instance, if activated, the ray line beam device will be shining the ray line beam for 45 seconds.

A golfer has to stand relatively square to the point of where he or she may wants to hit the ball and the golf ball itself. The positioning of a golfer's feet is critical to obtain this objective. For a person to stand facing the golf ball and wanting to be square with their feet in perfect line of the direction/point a person desires to hit a golf ball is nearly impossible.

The stance has a front and back foot. The front foot (10) is the foot that is closest to the desire destination or point that a person is trying to hit a golf ball. The back foot (11) is the furthest from this point of destination. Golfers are usually wearing golf shoes or some sort of shoe. The shoe covers the foot. A pair of shoes is relatively a mirror image identical to each other (Left and Right shoe). If a person was wearing a shoe with the right shoe on the right foot and the left shoe on the left foot; there would be an inside (1) and outside (2) of the shoes. The inside part (1) is the closest point of the shoes that could touch each other if the shoes were put together.

The inside of the shoes would be the best place to put the ray line beam device/apparatus (5) and the line/mark (12). If a person put there pair of shoes together on the soles (17) where the heals (14) were touching and the toes (13) were touching each other; a mark could be put on both of the shoes in the exact spot (16 & 18) of each other to attach the ray line beam device/apparatus (5) on the back shoe and apply the mark/line front shoe(12). The attachment has to be secure for the ray line beam device and marking. The ray line device has to be able to adjust so the ray line beam can project a ray line that is perpendicular to a “level” ground or the ray line beam device may have a self leveling ray line beam. There may be a ray line beam (20) that shines out to hit the golf ball. This ray line beam (7) will be 90 degrees from the ray line beam (6) for the target line and target.

1. I claim a device to produces straight ray line beams that attaches to a shoe and projects the straight ray line beam to a target line, target (even if off the ground), the opposing shoe and a golf ball:
Said first the device ray line beam has the ability to project a straight line on the ground, up a wall, to a target off the ground
Said first the device to produce a straight ray line beam has a “level” and or has the capability to self level the ray line beam
Said first the device to produce a straight ray line beam must be able to attach to a shoe securely (e.g. Clip, Velcro, some sort of adhesive, sown (stitched) . . . and or a combination)
Said first the device to produce a straight ray line beam can be permanently attached or detachable but must be able to be adjusted to be level and able to project a perpendicular ray line beam to a “level” ground even if not on level ground
Said first the device ray line beam is made to attach to the shoe be elevated off ground level to give the ray line beam the least amount of interference as possible with the least amount of interference to no interference to the person wearing the shoes
Said first the device ray line beam may have the ability to rotate to adjust the of the ray line beam to the shoe/foot attached on
Said first the device ray line beam will be able to shine a straight ray line beam towards the target
Said first the device ray line beam may be able to shine a second ray line beam 90 degrees away from the first ray line beam
Said first the device ray line beam may have an accessible on/off with also a timer to put the device in sleep mode or power off (e.g. automatic shut off may be set for 45 seconds)
Said first the device ray line beam may have a range of distance it may shine (e.g. 2 feet to 1500 feet)
